(19) United States
(12) Patent Application Publication
(10) Pub. No.: US 2026/0303910 A1
(43) Pub. Date: Oct. 1, 2026

(54) CONTENT-RELATED RECOMMENDATION AND ASSOCIATED REASONING

(71) Applicant: Sony Interactive Entertainment Inc., Tokyo (JP)

(72) Inventors: Ellana Fortuna, Redwood City, CA (US); Garganjot Kaur Kang, San Jose, CA (US); Ritagya Meharishi, Daly City, CA (US); Elizabeth Ruth Juenger, San Francisco, CA (US); Katherine Egeland, Oakland, CA (US)

(73) Assignee: Sony Interactive Entertainment Inc., Tokyo (JP)

(21) Appl. No.: 19/096,343

(22) Filed: Mar. 31, 2025

(51) Int. Cl. H04N 21/466; A63F 13/67; H04N 21/482

(52) U.S. Cl. CPC H04N 21/4666; A63F 13/67; H04N 21/4668; H04N 21/4826

(57) ABSTRACT

Techniques include receiving, by a gaming system, user specific data of a user and providing the user specific data to a machine learning model trained to determine a recommendation for a user device of the user, where the user device is integrated with the gaming system. Techniques further include generating the recommendation for the user device along with a reason for the recommendation, where the reason for the recommendation explains why the user is receiving the recommendation. Techniques further include presenting the recommendation and the reason for the recommendation to the user at the user device.

### BACKGROUND

Existing systems for delivering recommendations frequently rely on generalized algorithms that fail to account for the unique preferences, behaviors, or needs of individual users. As a result, there is a growing demand for improved methods and systems that provide personalized, user-specific recommendations to enhance relevance and user engagement.

### BRIEF SUMMARY

Techniques disclosed herein pertain to video game consoles. Particularly, techniques disclosed herein pertain to improving video game consoles by providing content-related recommendations and the associated reasoning.

In some embodiments, a method include receiving, by a gaming system including a processor and a memory, user specific data of a user. The method further includes providing, by the gaming system, the user specific data to a machine learning model trained to determine a recommendation for a user device of the user. The user device is integrated with the gaming system. The method also includes generating, by the gaming system using the machine learning model, the recommendation for the user device along with a reason for the recommendation. The reason for the recommendation explains why the user is receiving the recommendation. The method also includes presenting, by the gaming system, the recommendation and the reason for the recommendation to the user at the user device.

In some embodiments, the method further includes receiving, by the gaming system, general data of a group of users. The machine learning model is trained based at least in part on the general data.

In some embodiments, the method further includes: determining one or more propensities of the user based on the user specific data; assigning a score to each propensity of the user; determining the recommendation based on the score assigned to each of the one or more propensities of the user; and generating the reason for the recommendation based on the one or more scores.

In some embodiments, the user specific data comprises user interaction data with a program interface provided by the gaming system.

In some embodiments, the recommendation is generated based on two or more criteria for generating the recommendation. The reason for the recommendation is based at least in part on the two or more criteria.

In some embodiments, the user specific data is received from a second user device associated with the user. A predetermined set of data associated with the second user device is accessible by the gaming system.

In some embodiments, the method further includes implementing the recommendation at the user device automatically or in response to a user input.

In some embodiments, the method further includes receiving secondary user specific data. The secondary user specific data is collected after presenting the recommendation. The method further includes determining effect of the recommendation on user behavior based at least in part on the secondary user specific data. The effect comprises an indication of whether the recommendation has been implemented by the user. The method also comprises further training the machine learning model based at least in part on the secondary user specific data.

In some embodiments, the method further includes receiving a request from a user device to generate the recommendation based on identifying that a criteria for the user specific data is met on the user device.

In some embodiments, the machine learning model comprises one or more task specific intelligent agents. The reason for the recommendation is based at least in part on a specific task of the task specific intelligent agent.

In some embodiments, a gaming environment comprises the gaming system and the user device, and additional user devices providing general user data to the gaming system.

In some embodiments, the gaming environment further includes access to data from one or more content providers.

Some embodiments include a gaming system that includes one or more processors and one or more computer-readable media storing instructions which, when executed by the one or more processors, cause the gaming system to perform part or all of the operations and/or methods disclosed herein.

Some embodiments include one or more non-transitory computer-readable media storing computer-readable instructions that, when executed by one or more processors, cause the processors to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Features, embodiments, and advantages of the present disclosure are better understood when the following Detailed Description is read with reference to the accompanying drawings.

FIG. 1 illustrates an example of interaction with an entertainment environment, according to some embodiments of the present disclosure.

FIG. 2 illustrates an example of an entertainment environment, according to some embodiments of the present disclosure.

FIG. 3 illustrates an example of an entertainment environment, according to some embodiments of the present disclosure.

FIG. 4 is an illustration of an example training system for a machine learning model, according to one or more embodiments.

FIG. 5 illustrates an example of a user interface of an entertainment environment, according to embodiments of the present disclosure.

FIG. 6 illustrates an example of a flowchart for interacting with a gaming system, according to embodiments of the present disclosure.

FIG. 7 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth to provide a thorough understanding of certain embodiments. However, it will be apparent that various embodiments may be practiced without these specific details. The figures and description are not intended to be restrictive. Furthermore, well-known features may be omitted or simplified in order not to obscure the embodiment being described.

Techniques described herein can enable an entertainment environment to analyze user specific and general data to make content-based recommendations to a user and provide the user with visibility as to the reason for the recommendation. A recommendation can appear at a user interface (e.g., a game console) in various format such as at a home screen, as a popup window, etc. The recommendation can be visual and/or audio data provided to the user about, for example, recommended video trailers, games, songs, movies, product, optimal setting changes, and so on. A centralized system can pull data from various data sources both internal and external to the centralized system, analyze the data, and provide content-related recommendations on a platform associated with the central system along with a reason as to why the recommendation was made. Examples of internal and external data includes one or more of user’s active subscriptions, unique discounts for the user, user’s health data, music data, events (e.g., sports events, music festivals, etc.) happening at user’s location, among others. It should be understood that the embodiments described herein may not be limited to entertainment environments and can be applies to provide a user with various recommendations that can be improved using the techniques described herein (e.g., travel recommendations, news articles, shopping deals, etc.).

In some embodiments, a recommendation may be presented to the user in a display of an entertainment environment. Alternatively, the recommendation may be output as audio. The recommendation may be triggered by an event such as the user reaching a point in a video game or movie, upon request, or at a pause screen. Additionally, the recommendation can appear as a “surprise” element such as a surprise recommendation while playing a video game or after achieving a certain goal in the video game. The recommendation can include a reason for the recommendation. To illustrate, a user can be playing a FIFA game and a surprise popup can appear on the screen recommending a nearby match and a link to purchase tickets to the match. The recommendation can further include the reason for the recommendation such as “Based on your interest in FIFA and your location in New Jersey, we think you would like to attend the 2026 FIFA World Cup final at MetLife Stadium.” The reason for the recommendation can be presented along with the recommendation or if the user performs an action to request the reason such as hovering over the recommendation, clicking on a particular icon, providing an audio command. The centralized system can utilize a user profile that can be connected to various user accounts to retrieve user specific data. Additionally, the centralized system can gather additional internal or external data by associating a user’s profile with additional programs to determine the interests of the user.

The interests of a user can be determined using game console data. The game console data may be received from a game console associated with a user account of the user, applications executing on the game console and associated with the user account (e.g., video game applications, news applications, music applications, social media applications, etc.), and/or applications executing remotely from the game console and associated with the user account (e.g., video game applications, news applications, etc.). The game console data may be associated with a user account used with a game console. The game console data may include explicit and/or implicit indications of interests associated with the user account. For example, an explicit indication of an interest may include an answer to a question where user input was received indicating that a user of the user account likes adventure games, likes realistic looking games, likes sandbox games, likes co-op games, likes player versus player games, etc. An implicit indication may be an interest indication determined from an analysis of game console data that does not explicitly indicate the interest. For example, game console data representing that the user account owns a lot of sandbox games can implicitly indicate that the user likes sandbox games. As another example, game console data representing that the user account has recently played 30 hours of a single sports game may indicate that a user has an interest in sports games (e.g., possibly even if the user account also owns a lot of sandbox games but has not recently played them).

The game console data can be input to an interest determination module (e.g., including a machine learning model) that is configured to determine one or more interests associated with a user account based on game console data associated with the user account. The machine learning model may determine the interests of the user based on patterns recognized from training of the machine learning model. The training data may be based on game console data of a set of users and corresponding interests. The interests may be determined based on features (e.g., indicating whether a video game is a sandbox game, a simulation game, a building game, a coop game, etc.) of video games in a game library associated with the set of users.

The interests of the user may also be potential interests of a user and can be determined based one or more criteria (e.g., the player is in a particular geographical location, the player has completed a game, etc.). The potential interests of a user may also be determined based on general user data such as data about a group of players (e.g., most players that play FIFA stop playing after completing level 2). The general data may be data of all users of an entertainment environment or a subgroup of users of an entertainment environment (e.g., users who are located in the United States).

After one or more interests associated with a user account are determined, techniques may further enable a recommendation to be generated (e.g., using a machine learning model) based on the interests and potential interests of the user. The recommendation may include content from a general set of content compiled from one or more providers (e.g., video game developers, retailers, marketing, players, and/or streams, etc.). The recommendation may be associated with a user account so that it can be presented to a user of the user account along with the reason for the recommendation. For example, a video game recommendation may be pushed to the user in a notification for a video game they might find appealing along with a notification that the reason for the recommendation is that the user’s friends (e.g., user profiles listed in a contact list of the user’s profile) are playing the video game. In an example, a list of recommended songs may be presented to the user and the reason for the recommendation (e.g., recommending musing of a certain genre because the user has recently attended a concert of an artist in that genre).

Techniques described herein can enable an entertainment environment to analyze user specific and general data to make content-based recommendations to a user and provide the user with visibility as to the reason for the recommendation in real-time. These embodiments offer significant advantages over existing systems delivering suggestions in real time, dramatically reducing delays compared to traditional methods like promotional emails, which often operate on a 24-hour or longer turnaround time. Real-time recommendations allow gaming systems to respond instantly to user actions, such as suggesting a relevant downloadable content (DLC) when a player completes a game's main storyline or highlighting a multiplayer game their friends are currently playing. This immediacy is particularly impactful for live-service games, where timely engagement with seasonal events, limited-time offers, or competitive matches can drive user participation and satisfaction. By seamlessly integrating recommendations into the gaming experience, the system ensures that users are presented with valuable content exactly when they are most likely to engage with it, advancing the effectiveness of real-time marketing (RTM) strategies and fostering a dynamic, personalized gaming environment. By optimizing data processing and reducing delays, the system ensures a seamless and dynamic user experience while maintaining high performance and scalability.

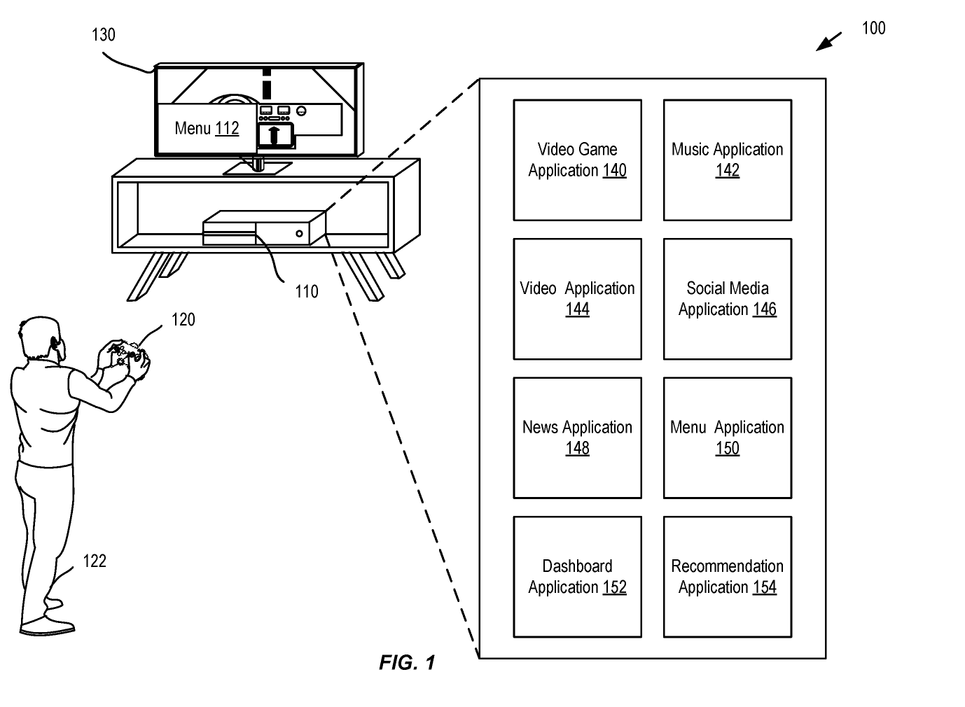

FIG. 1 illustrates an example of an interaction with an entertainment environment 100, according to some embodiments of the present disclosure. As illustrated, the computer system includes a video game console 110, a video game controller 120, and a display 130. Although not shown, the computer system may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). A user 122 operates the video game controller 120 to interact with the video game console 110. These interactions may include playing a video game presented on the display 130, interacting with a menu 112 presented on the display 130, and interacting with other applications of the video game console 110 (e.g., with media applications to stream media from an online content source or to play a media file from the local storage of the video game console 110).

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented form local storage of the video game console 110. Further, other applications can be likewise included in the video game console 110, such as a chat application. The availability of a video game application, media application, and/or other type of computer application to the user 122 via the video game console 110 can depend on a user identifier of the user 122 (e.g., upon a login to the video game console 110, the availability of the computer applications can depend on the user identifier used in the login).

In addition, the video game console 110 includes a menu application 150, a dashboard application 152, and a recommendation application 154. The menu application 150 can present a home user interface (UI) in a GUI of the display 130. The dashboard application 152 can present an arrangement of interactive UI widgets in a dashboard page on the GUI. And the recommendation application 154 may implement a gaming system or portions of a gaming system for generating recommendations. The gaming system can present, store, and/or transmit the generated recommendations.

The video game controller 120 is an example of an input device. The video game controller 120 may allow the user 122 to interact with one or more GUIs presented by the video game console 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content (e.g., illustrated as a car race video game content) on the display 130. Upon user input from the video game controller 120 (e.g., a user push of a particular key or button), the rendering process also presents the menu 112. Additionally, or alternatively, the menu 112 may be presented as an initial landing page in response to a user powering-on the video game console 110 and/or waking the video game console 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the menu application 150. Upon receiving a user input from the video game controller 120 requesting interactions with the menu 112, an underlying application (e.g., the menu application 150, the dashboard application 152, etc.) supports such interactions by updating the menu 112 and launching any relevant application in the background or foreground. The user 122 can exit the menu 112 or automatically dismiss the menu 112 upon the launching of an application in the background or foreground. Upon exiting the menu 112 or the dismissal based on a background application launch, the user control changes from the underlying application to the video game application 140.

As described in more detail below, the dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple column element with textual or graphical description in each column, and the like. As described further, below, widgets may be presented with application information and/or dynamic content presented with the widget in a media library. For example, the dashboard application 152 may generate and/or present widgets associated with media applications, system applications and/or services, video game applications, or the like.

As described in more detail below, the dashboard application 152 may be executed via multiple avenues of ingress. For example, the dashboard application 152 may be executed by a pre-defined user interaction (e.g., via controller 120, a voice command from the user 122, activating and/or powering-on the video game console 110 etc.) and/or by navigating one or more menus and/or sub-menus of the video game console 110 (e.g., menu 112).

The video game console 110 may generate game console data. The game console data may include data generated by one or more applications running on the video game console 110. For example, the video game application 140 may generate video game application data. The video game application data may include data representing levels completed, achievements unlocked, and missions accomplished, within the video game, time of day when the video game application is used, session duration, and total time spent playing the video game, how often the user 122 plays the video game, choices made during gameplay (e.g., character selection, weapon preferences, or strategies), preferred difficulty level (e.g., easy, medium, hard), location data, game genre, engagement with multiplayer features, chat data, user group data (e.g., who the user 122 plays with), what people have taken screenshots of, an artistic style, and/or a mechanic, etc.

In another example, the news application 148 may generate news data. The news data may include data representing specific articles or topics the user 122 reads (e.g., an article about an upcoming video game or video game feature), how much time the user 122 spends reading a particular article or topic, how often the user opens the app or reads articles, how the user 122 navigates through the app (e.g., scrolling speed, clicks on headlines, links, or ads), keywords or topics the user searches for within the application, content the user chooses to save for later or mark as important, articles or topics the user shares via the social media application 146, use of specific app features, such as notifications, comment sections, or personalization tools, news sources, and/or authors (e.g., a game developer), etc.

In another example, the music application 142 may generate music data. The music data may include data representing frequency of music application usage, time of day when the application is used, and session duration, songs or playlists that are played, skipped, paused, or replayed, songs, albums, artists, or playlists that the user marks as "liked," "favorited," or adds to their library, terms or keywords used by the user in the application’s search feature, personalized playlists created by the user, which may indicate preferences for specific genres, moods, or themes, songs, playlists, or albums shared with others via the social media application 146, genres the user listens to most often (e.g., rock, jazz, pop, classical), specific artists or albums that are repeatedly played or followed, selection of mood- or activity-based playlists (e.g., "workout," "relaxation," "study"), songs or genres associated with specific regions or cultures.

In another example, the video application 144 may generate video data. The video data may include data representing videos (e.g., videos related to certain video games, streams related to certain video games) or shows watched, including completion rates (e.g., fully watched, partially watched, or abandoned), search terms or keywords entered into the video application’s search bar, indicating specific interests or queries, actions such as liking, disliking, commenting, sharing, or saving videos to playlists or watchlists, information about when videos are paused, rewound, fast-forwarded, or skipped, time spent watching videos, session lengths, and binge-watching patterns, engagement with suggested videos or curated playlists, types of content frequently viewed (e.g., comedy, drama, sci-fi, documentaries, tutorials), specific creators, influencers, or channels the user 122 follows or frequently watches, interest in specific topics (e.g., cooking, fitness, gaming, technology, travel), languages of the videos watched, reflecting linguistic preferences or fluency, preference for certain formats, such as short-form videos, live streams, or full-length movies, and/or online vs. offline viewing habits, etc.).

In another example, the dashboard application 152 may generate dashboard data. The dashboard data may include data representing application usage patterns, customization choices (e.g., user selected widgets, backgrounds related to a certain video game, layouts, themes, etc.), responses to application notifications, and/or games on a wish list, etc.

In another example, the social media application 146 may generate social media data. The social media data may include data representing posts liked, shared, commented on, saved, or bookmarked, time spent viewing specific posts, videos, or stories (e.g., scrolling past vs. lingering on content), keywords, hashtags, profiles, or topics searched within the social media application 146, frequency, timing, and type of content shared by the user (e.g., text, images, videos, links), views, reactions, and replies, responses to interactive features like polls, quizzes, or surveys within the social media application 146, topics of interests, and/or followed accounts, etc.

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

The video game console 110 shown in FIG. 1 may be a part of an entertainment environment.

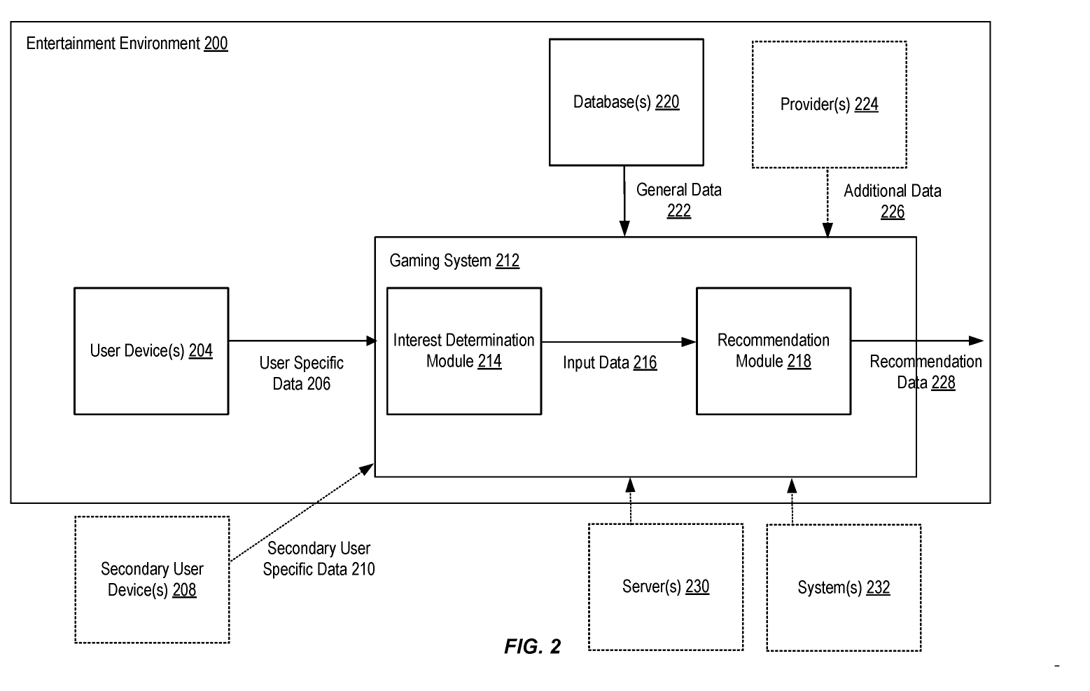

FIG. 2 illustrates an example of an entertainment environment 200, according to some embodiments of the present disclosure. The entertainment environment 200 can include user device(s) 204, a gaming system 212, a database(s) 220, provider(s) 224, and a recommendation module 218. Additionally, the entertainment environment 200 may receive and send data from/to secondary user device(s) 208. The gaming system 212 can receive user specific data 206 from the user device 204. The gaming system 212 can receive general data 222 from the database 220 and the additional data 226 from the provider(s) 224. The interest determination module 214 of the gaming system 212 can generate input data 216 that is input into the recommendation module 218. The recommendation module 218 can output recommendation data 228.

The operations of the entertainment environment 200 can be generalized into four sections: data collection, interest determination, recommendation generations, and presentation to the user.

### I. Data Collection

The gaming system 212 can receive various data from both internal sources (e.g., user device 204, database 220), integrated sources (e.g., providers 224), and/or external sources (e.g., secondary user device 208).

The user device 204 can be a game console as described above in connection with FIG. 1. The user specific data 206 can include patterns that are indicative of interest of users who use the user device. The user device 204 may be associated with a specific user account, such as a user account signed into the user device 204 while the user device 204 is being used. The user specific data 206 may be received by the gaming system 212 from the user device 204, server(s) 230, and/or from system(s) 232 that store game console data. The user specific data 206 may include data associated with a user account and collected from multiple user devices over a period of time.

Additionally, one or more secondary user devices 208 can store and transmit secondary user specific data 210. The secondary user devices 208 can be, for example, wearable devices like smartwatches and fitness trackers. The secondary user specific data 210 from such devices can include data on physical activity, heart rate, or stress levels, which can inform recommendations for fitness-based games, relaxation experiences, or VR activities. The secondary user devices 208 can also be augmented reality (AR) glasses which can capture spatial and environmental data. Additional types of devices can include smartphones, tablets, voice activated assistances and health devices, each capable of collecting various additional secondary user specific data 210. The secondary user devices 208 can operate independently of the entertainment environment 200 but can integrate valuable data to the gaming system 212 to further enhance the content-based recommendations.

Next, the database 220 can include general data 222 that supports system operations, game mechanism, and user engagement. For example, the database 220 can include game environment data, such as in-game world states, weather conditions, and dynamically changing elements like non-playable character (NPC) behavior or item spawn locations. The database 220 can include general user engagement metrics, such as average time spent on different game modes, popular levels or maps, and frequency of activity across various game features. The general user engagement metrics can be used to identify patterns in user behavior, such as which modes are most engaging or which areas of the game require balancing or improvement. The database 220 can also include game performance metrics, such as frame rates, load times, crash log, and latency statistics, which are critical for optimizing the technical aspects of the game and ensuring smooth gameplay. The database 220 can include inventory data, such as available in-game items, skins, or vehicles, as well as data on how frequently these items are used or unlocked by players. The database 220 can include event participation data, such as the number of players joining seasonal or time-limited events, their completion rates, and the outcomes of these events. The database 220 can also include leaderboard ranking and information for competitive or cooperative play as well as matchmaking data, such as player skill ratings, connection quality, and regional-based preferences. Additionally, the database 220 can include game rule configurations and artificial intelligence (AI) behavior patterns.

The database 220 can include user-specific data such as personal information, account details, subscription tiers, playtime statistics, friend lists, purchase history, and feedback provided by the user. The database 220 can also include user profile data such as gaming preferences like favorite genre, difficulty levels, unlocked achievements, skill level, in-game behavior, and avatar customization. The database 220 can further include comprehensive data such as game-specific data, content data, usage metrics, content recommendation data, community and social data, system data, and cross-platform data.

The database 220 can be embedded directly within the gaming console or system and stored on a local hard drive or solid-state drive. The gaming system 212 can communicate with the database 220 using an application programing interface (API) or file system integrations. Additionally, the one or more databases 220 can be hosted externally, such as on cloud servers. Cloud databased can communicate with the gaming system via internet protocols, such as RESTful APIs or WebSocket connections, providing real-time updates and synchronization. Additionally, hybrid setups are possible, where certain data (e.g., critical game files) is stored locally, while dynamic data (e.g., live game stats) resides in the cloud. The database 220 can also be integrated into third party services, such as gaming networks (e.g., PlayStation Network or Xbox Live). These external databases communicate with the gaming system through secure authentication protocols and encrypted data streams to ensure privacy and integrity. Furthermore, certain gaming systems may utilize edge computing, where smaller, distributed databases are located closer to the end user to reduce latency for high-performance scenarios like competitive gaming. The gaming system 212 can interact with the databases 220 through middleware or game engines which provide structured pathways for database queries and responses.

Additionally, the gaming system 212 can receive the additional data 226 from the providers 224. The providers 224 can be, for example, multimedia providers like YouTube, Twitch, and Spotify. The additional data 226 from the provider 224 can include stored user interactions with gaming videos, live streams, or soundtracks. The providers 224 can also be e-commerce platforms which can include the additional data 226 about popular purchases, wish lists, and in-game preferences. Additional types of providers 224 can include, for example, social media platforms and wearable devices.

The gaming system 212 can receive the relevant data for determining the interest of a user and ultimately to generate a content-based recommendation for the user along with the reason for the recommendation.

### II. Interest Determination

As discussed above, the gaming system 212 receives the user specific data 206, the general data 222 and potentially the secondary user specific data 210 and the additional data 226. The data may be input into the interest determination module 214 which can be one or more machine learning models trained to determine one or more interests of a user. The interest determination module 214 can be a machine learning model trained to analyze patterns in behavior and preferences. Training of the machine learning model is further described below. For example, a machine learning model can be trained to compare the user specific data 206 to general data 222 about a group of similar users (e.g., users playing a similar or same game, users that are geographically located in a particular region, friends of the user) to identify shared preferences for games, genres, and content. The one or more machine learning models can be trained to analyze the attributes of items (e.g., game features, themes, or mechanics) that a user has engaged with to recommend similar content. The one or more machine learning models can include a model that can process text-based inputs, such as user reviews, chat logs, or search queries, to infer interests from sentiment and keyword analysis. The one or more machine learning models can include a deep learning model that can identify complex patterns in user behavior by processing large datasets, such as playtime statistics, in-game actions, and purchase histories. The one or more machine learning model can include a reinforcement learning model that can adapt to a user’s changing interests by learning from real-time interactions, such as clickstream data and game selection. Additionally, the one or more machine learning models can include clustering models that can group users into segments based on shared characteristics or behaviors.

An interest of a user may represent something that the user finds of interest, enjoyable, fun, and/or engaging, etc. Interests may change over time. Something may be of interest to a user because of a combination of factors. The interests of a user can encompass both their explicit preferences and potential inclinations, derived from their behaviors, interactions, and contextual data. Explicit interests can include the genres of games they play, the features or mechanics they engage with, and the content they actively seek out, such as downloadable content (DLCs) or multiplayer modes. Potential interests can be inferred from broader contextual patterns, such as activities popular among their friends, trends within their gaming community, or preferences observed in users with similar gaming habits. These potential interests may also stem from related content, such as games with similar themes, art styles, or narratives to those the user already enjoys. Additionally, interests can be influenced by external factors, like seasonal events, emerging genres, or recommendations from influencers and peers. For example, if a user has been playing a lot of country music, the interest determination module 214 may determine that the user likes country music. In an example, if a user has been playing an aggressive game for a while, the interest determination module 214 may determine that the user may be interested in listening to calming music. In an example, a user often skips around while watching a movie, and therefore the interest determination module 214 may determine that the user prefers to watch highlights of a movie instead of the full piece of content.

The interest determination module 214 may be informed by the user specific data 206. For example, the user specific data 206 may include user profile data which includes settings selected by the user. The user may limit the data that can be used to generate content-based recommendations (e.g., opt out of using health data and hide my purchase history). The user may also inform of the type of recommendations they would like to receive (e.g., send me music recommendations). The user specific data 206 can include additional information regarding the user’s preferences and controls. For example, users can opt into recommendation systems by specifying which data sources they are willing to share, such as enabling location data for region-specific content suggestions while choosing to exclude search history or in-game behavior. Some users may prefer to restrict recommendations altogether. Other users may select certain categories of recommendations, such as game suggestions based on popular community trends, but exclude recommendations tied to social connections or purchase history.

Based on the various data and the potential user restrictions, the interests and potential interest of a user can be determined by the interest determination module 214. The interests can be input as input data 216 to the recommendation module 218 for generating a content-based recommendation and associated reasoning.

### III. Recommendation and Associated Reasoning

The recommendation module 218 may receive the input data 216 from the interest determination module 214 indicating the interests and potential interests of a user. The recommendation module 218 can also receive the user specific data 206, secondary user specific data 210, the general data 222, and/or the additional data 226. The recommendation module 218 can include one or more machine learning models trained to generate recommendation data 228 which can be content-based recommendations for a user as well as a reasoning for the recommendation. Training of the machine learning model is further described below.

The recommendation module 218 may receive content and data from the databases 220 and the providers 224 based on the input data 216. For example, if the interest determination module 214 determines that the user likes action-adventure games, the recommendation module 218 can request and/or receive content and data related to popular action-adventure games from the database 220 and the providers 224 based on the input data 216. For example, if the interest determination module 214 determines that the user enjoys action-adventure games but has recently been playing retro style games, the recommendation module 218 may request and/or receive content and data related to popular action-adventure platformers with retro aesthetics from the databases 220 and the providers 224 based on the input data 216.

Based on the received and/or requested content and data, the recommendation module can generate recommendation data 228 which can be one or more content-based recommendations and the reason for the recommendation. The reason for the recommendation is determined by the recommendation module 218 and can be informed by the input data 216 indicating the interest of the user as determined by the interest determination module 214. As discussed above, interests of a user may represent something that the user finds of interest, enjoyable, fun, and/or engaging, etc. The interests of a user can be determined based on user behavior and preferences or can be inferred based on a group of similarly situated users (e.g., users playing a similar or same game, users that are geographically located in a particular regions, friends of the user) to identify shared preferences for games, genres, and content.

The recommendation may be multi-criteria, i.e., based on a number of interests or a combination of interests. Interests of a user may be ranked or given priority based on a number of factors such as recency, relevance, and frequency. A single recommendation or set of recommendations can be generated based on a number of interests or multiple recommendations or set of recommendations can be generated based on one or more interests. For example, a multi-criteria recommendation can be based on the least three games a user played, analyzing their themes, mechanics, or genres to suggest similar titles. In an example, social data can be used, where the recommendation can be based on identifying the games most frequently played by the user’s friends, those games can be fed to the machine learning model of the recommendation module 218 which can combine the data with additional factors, such as popularity trends, user preferences, or community feedback, to recommend a refined set of games to the user. Similarly, the system can prioritize recommendations based on the intersection of the user’s activity patterns and broader influences, like seasonal events or trending content in the gaming ecosystem.

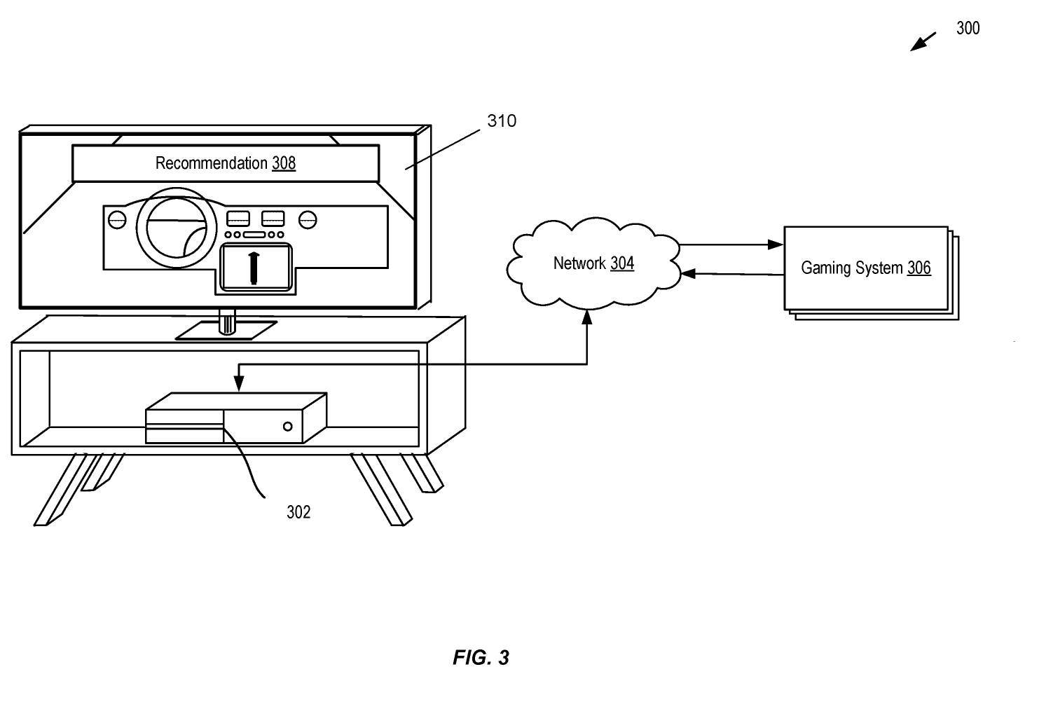

FIG. 3 illustrates an example of an entertainment environment 300, according to some embodiments of the present disclosure. The entertainment environment can include game console 302, network 304, gaming system 306, and display 310. The display can present recommendation 308.

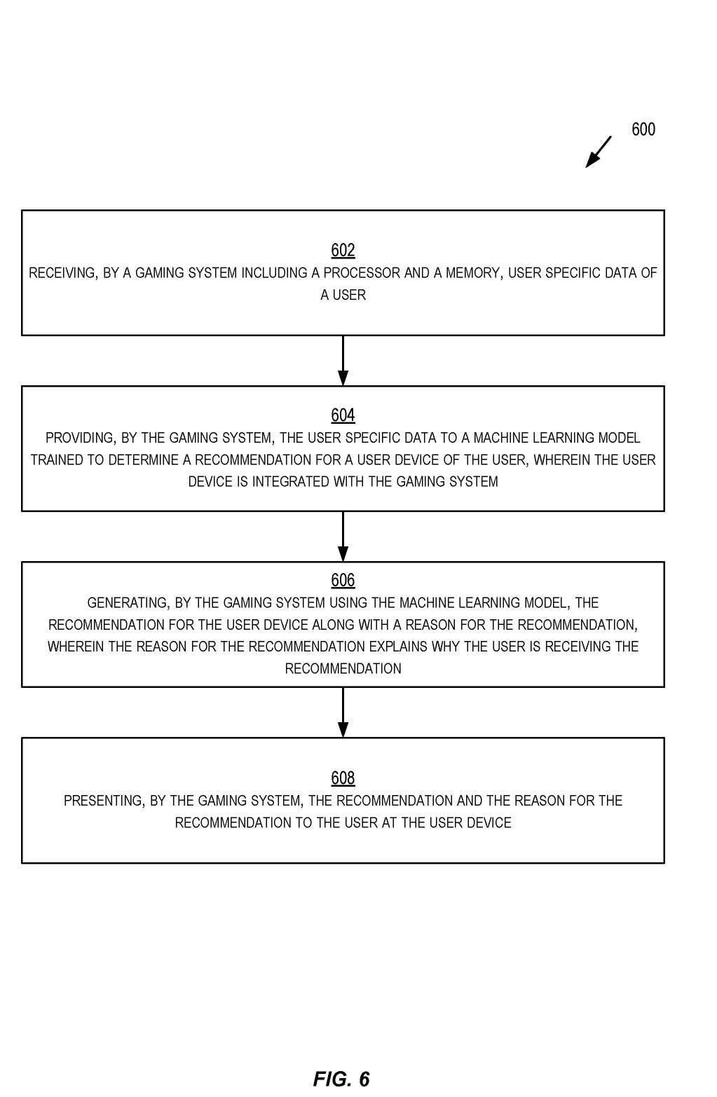

The gaming system 306 may receive the game console data from the game console 302, the game console data may be used to generate one or more content-based recommendations and reasoning for the recommendations. A recommendation may be transmitted by the game console 302 and presented by the display 310. The gaming system 306 may include one or more systems. Exemplary components of a gaming system are described below in connection with FIG. 6. The system(s) of the gaming system 306 may execute code that processes console data (e.g., game data, image data, scene data, audio data, text data, vector data, conditions, etc.). The system(s) may include one or more machine learning models (e.g., machine learning models with parameter weights, a classification model, a diffusion model, a clustering machine learning model, etc.). Systems are referred to and described throughout the description herein. The systems may be implemented using hardware (e.g., a processor, a memory, and/or a graphics card, etc.). The systems may be implemented using a rule based approach (e.g., using a ruleset (e.g., outlining specific conditions and actions to follow)), an algorithm, and/or a trained machine learning model. A system included in the system(s) may include a service and/or hardware local or remote to the other system(s). A rule-based approach may ensure consistent and logical outcomes based on established criteria. A machine learning model can enable the system to adapt and improve its performance over time. Implementing one or more of the system(s) with a machine learning model and/or a rule based approach can enable the system(s) to handle a wide variety of tasks, from dynamic decision-making to structured, rule-driven processes, depending on the requirements of the gaming system 306. In certain embodiments, the game console 302 is implemented by a server.

The network 304 may be configured to connect game console 302 and the gaming system 306, as illustrated. The network 304 may be configured to connect any combination of the system components. In certain embodiments, the network 304 is not part of the entertainment environment 300. For example, the gaming system 306 can run locally on the game console 302 and/or one or more of the system(s) may run locally on the game console 302. Each of the network 304 data connections can be implemented over a public (e.g., the internet) or private network (e.g., an intranet), whereby an access point, a router, and/or another network node can communicatively couple the game console 302 and the gaming system 306. A data connection between the components can be a wired data connection (e.g., a universal serial bus (USB) connector), or a wireless connection (e.g., a radio-frequency-based connection). Data connections may also be made using a mesh network. A data connection may also provide a power connection. A power connection can supply power to the connected component. The data connection can provide for data moving to and from system components. One having ordinary skill in the art would recognize that devices may be communicatively coupled using a network (e.g., a local area network (LAN), wide area network (WAN), etc.). Further devices may be communicatively coupled through a combination of wired and wireless means (e.g., wireless connection to a router that is connected via an ethernet cable to a server).

The network 304 can transmit the generated recommendations and associated reasoning to the game console 302. Upon the game console 302 receiving the generated recommendations and associated reasoning, the game console 302 can store the recommendation and associated reasoning and associates the recommendation and associated reasoning with a user account of the user. In some embodiments, upon the game console 302 receiving the recommendations and associated reasoning, the game console 302 can present the recommendation using a user interface (e.g., display 310). For example, a user may be presented with and able to view the generated recommendation and associated reasoning. In some embodiments, the recommendation(s) can be output via one or more devices associated with the user account (e.g., a mobile phone, a tablet, a computer, a television, another game console, etc.).

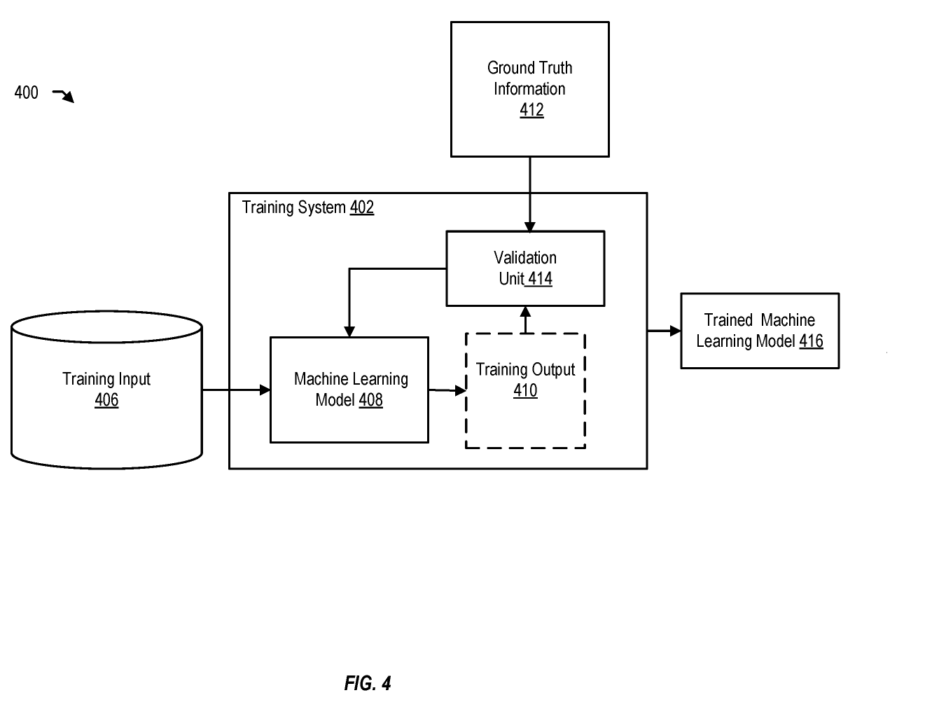

FIG. 4 is an illustration 400 of an example training system for a machine learning model, according to one or more embodiments. As illustrated, a training system 402 can be configured to train a machine learning model 408 to be capable of processing console data (e.g., user specific data 206 described above) and system data (e.g., general data 222, additional data 226, and secondary user specific data 210 as described above). The training system 402 can receive a training input 406 as an input. The training input 406 can be processed by the machine learning model 408. The machine learning model can generate a training output 410, which can include a content based recommendation and associated reasoning.

To guide the training process, the training system 402 can use ground truth information 412, which can act as a reference dataset containing predefined mappings between user data and user’s confirmed recommendation preferences. The ground truth information 412 can also be a dataset containing predefined mappings between general user data and confirmed successful recommendations. The training system 402 can provide the ground truth information 412 to the validation unit 414, which can evaluate the training output 410 generated by the machine learning model 408. For example, the validation unit 414 can compare the model's training output 410 against the ground truth information 412 and assess its accuracy and relevance. Through this comparison, the training system 402 system can identify discrepancies and provide feedback to refine the machine learning model 408.

To improve the accuracy, the training system 402 can update the weights of the machine learning model. This training output 410 can be iteratively refined as the machine learning model 408 undergoes additional training cycles. The feedback loop ensures that the machine learning model 408 can learn to produce accurate and contextually appropriate results over time.

Once the training process achieves a satisfactory level of accuracy and consistency, the training system 402 can output the trained machine learning model 416. This trained machine learning model 416 can be capable of analyzing console data and provide users with content based recommendations and associated reasoning based on their actual and presumed interests. The overall system is designed to streamline the process of identifying relevant content and visibility as to the reasoning for the identified content to users, enhancing efficiency by automating the analysis of vast amount of user data, centralizing data from multiple sources, and using machine learning models to process the data in real time.

### IV. Presentation

The recommendation(s) can be a video file, audio file, and/or image file that is/are used to present content on a user interface of a device (e.g., a game console). Recommendations can be integrated into the gaming system’s dashboard or home screen in visually appealing ways, such as personalized carousels, lists, or tiles labeled with and include a reasoning for the recommendation such as “Because You Played FIFA,” “Popular Among Your Friends,” or “Recommended Based on Your Recent Activity.” For example, a game tile might feature a label like “Trending Among Players Who Enjoyed FIFA” or “4 Friends Are Playing This Right Now.” Considering multiple interests of a user and criteria for the recommendation can result in a more narrowly tailored, personal recommendation. For example, a user who enjoys cooperative multiplayer games might be recommended a trending title that their friends are actively playing, reinforced by the system identifying shared mechanics or genres with the user’s past favorites. These explanations not only help users understand why a game is being suggested but also make the recommendations feel more relevant and personalized.

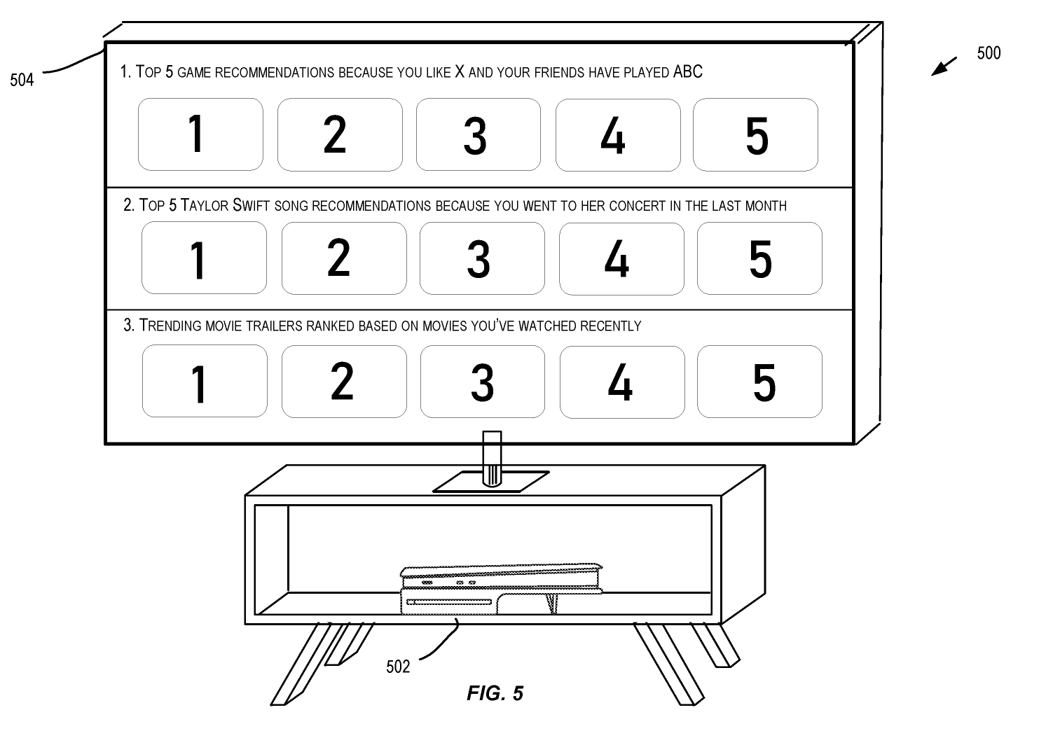

FIG. 5 illustrates an example of a user interface of an entertainment environment 500, according to embodiments of the present disclosure. The entertainment environment can include game console 502 and display 504. As discussed above, upon the game console 502 receiving the recommendations and associated reasoning, the game console 502 can present the recommendation using a user interface (e.g., display 504). For example, the recommendations and associated reasoning can be presented as lists of carousels as illustrated. Each carousel can include tiles with various recommended content. In some examples, to display the associated reasoning, the carousels can include the reasoning in the heading such as “Top 5 game recommendations because you like X and your friends have played ABC,” “Top 5 Taylor Swift song recommendations because you went to her concert in the last month.”

The reasoning behind the recommendation can be presented with the recommendation or can be presented upon request by a user. For example, the user interface can feature a hover-over or expandable elements that provide additional reasoning and context for the recommendation. For instance, hovering over a title could display a breakdown such as “Recommended because you enjoy strategy games, and this title has a 95% rating among similar players.” The additional reasoning can include social integration such as “Your friend Alex has played 10 hours of this game.” Notifications or banners can also highlight time-sensitive recommendations, such as discounts, seasonal events, or newly released content, accompanied by reasoning like “Limited-time event for fans of [Genre].” A user can also have the option to sort recommendations (e.g., by genre, multiplayer compatibility, or trending status) ensures that users can easily browse suggestions in a way that aligns with their preferences.

### V. Example Process

One having ordinary skill in the art with the benefit of the present disclosures would recognize how other models described herein could be trained to perform the describes processing. The techniques for training models described herein are not meant to be limiting, but as example implementations.

FIG. 6 illustrates an example of a flowchart 600 for interacting with a gaming system (e.g., gaming system 212 or 306 described above), according to embodiments of the present disclosure. The process may be performed to generate a content-based recommendation and associated reasoning based on interests of a user.

The processing depicted in flowchart 600, and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in flowchart 600, other FIGS., and described herein are intended to be illustrative and non-limiting. Although flowchart 600, and other FIGS, depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in flowchart 600, and other FIGS, may include a greater number or a lesser number of steps than those depicted in the respective FIGS.

In some embodiments, the flowchart 600 can be triggered by a gaming system receiving a request from a user device to generate a recommendation based on identifying that one or more criteria for the user specific data is met on the user device. By utilizing various criteria, the gaming system can ensure that suggestions are timely, relevant, and engaging for the user. Time-based criteria, for instance, can include recommending seasonal-themed games or content during specific times of the year, such as winter-themed games in December or Halloween events in October. Social activity can also serve as a trigger, such as when a user’s friends are actively playing a multiplayer game, prompting a recommendation to join them. In-game milestones are another criterion; for example, when a user reaches a particular point in a game (e.g., such as completing the main storyline or unlocking a specific achievement) the system may recommend expansion packs, similar titles, or additional challenges. Other triggers can include inactivity, where a user who hasn’t logged in for a while may receive a recommendation for trending games to re-engage them, or new content releases, where users who played a prior installment of a franchise are notified about a sequel or DLC. By incorporating diverse triggers like these, the gaming system can deliver suggestions that feel timely, personalized, and closely aligned with the user’s current gaming context.

At 602, a gaming system, including a processor and a memory, can receive user specific data of a user. The user specific data (e.g., user specific data 206 described above) can be game console data and can include patterns that are indicative of interest of users who use the game console. The game console data may include data generated by one or more applications running on the game console. For example, a video game application may generate video game application data. The video game application data may include data representing levels completed, achievements unlocked, and missions accomplished, within the video game, time of day when the video game application is used, session duration, and total time spent playing the video game, how often the user plays the video game, choices made during gameplay (e.g., character selection, weapon preferences, or strategies), preferred difficulty level (e.g., easy, medium, hard), location data, game genre, engagement with multiplayer features, chat data, user group data (e.g., who the user 122 plays with), what people have taken screenshots of, an artistic style, and/or a mechanic, etc.

The user specific data can be received by the gaming system from one or more user device(s) (e.g., the game console). The user device can be associated with a specific user account, such as a user account signed into the user device while the user device is being used. The user specific data can be data collected over a period of time and can include data associated with a user account and collected from multiple user devices.

In some embodiments, additional user specific data (e.g., secondary user specific data 210 described above) can be received from the additional user devices (e.g., secondary user device 208 described above) associated with the user (e.g., Apple Watch), where a predetermined set of data associated with the additional user devices is accessible by the gaming system. For example, additional data from such devices can include data on physical activity, heart rate, or stress levels, which can inform recommendations for fitness-based games, relaxation experiences, or VR activities. The additional user devices can operate independent of the gaming system and/or an entertainment environment of the gaming system.

At 604, the gaming system can provide the user specific data to a machine learning model trained to determine a recommendation for the user. The recommendation may be output on a user device of the user, where the user device is integrated with the gaming system. The recommendation may be based on one or more interests of the user. An interest of a user may represent something that the user finds of interest, enjoyable, fun, and/or engaging, etc. Interests may change over time. Algorithms implemented by the gaming system and the machine learning model may use the dynamic data to provide relevant recommendations based on recent preferences of the user. Something may be of interest to a user because of a combination of factors. The interests of a user can encompass both their explicit preferences and potential inclinations, derived from their behaviors, interactions, and contextual data. Explicit interests can include the genres of games they play, the features or mechanics they engage with, and the content they actively seek out, such as downloadable content (DLCs) or multiplayer modes. Potential interests can be inferred from broader contextual patterns, such as activities popular among their friends, trends within their gaming community, or preferences observed in users with similar gaming habits. These potential interests may also stem from related content, such as games with similar themes, art styles, or narratives to those the user already enjoys. Additionally, interests can be influenced by external factors, like seasonal events, emerging genres, or recommendations from influencers and peers.

In some embodiments, the machine learning model can be trained using general data of a group users. The general data can be for a group of users that fit in a particular criteria (e.g., play similar games, geographically located near each other, age, etc.) In some examples, the general data can include game environment data, such as in-game world states, weather conditions, and dynamically changing elements like non-playable character (NPC) behavior or item spawn locations. In some examples, the general data can include general user engagement metrics, such as average time spent on different game modes, popular levels or maps, and frequency of activity across various game features. The general user engagement metrics can be used identify, such as which modes are most engaging or which areas of the game require balancing or improvement. In some embodiments, the machine learning model comprises one or more task specific intelligent agents where the reason for the recommendation is based at least in part on a specific task of the task specific intelligent agent.

In some embodiments, the interest(s) of the user and the recommendation can be based on recent activity of the user. For example, the user specific data can comprise user interaction data with a program interface provided by the gaming system. The interaction data can then be used to determine the interest(s) of the user and used to generate the recommendation and associated reasoning. For example, the interests of the user can be determined based on user-specific and general data related to leaderboard ranking and information for competitive or cooperative play as well as matchmaking data, such as player skill ratings, connection quality, and regional-based preferences.

In some embodiments, the interest(s) of the user (and ultimately the recommendation and reasoning) can be based on multiple criteria for generating the recommendation i.e., based on a number of interests or a combination of interests. For example, interests of a user may be ranked or given priority based on a number of factors such as recency, relevance, and frequency. A single recommendation or set of recommendations can be generated based on a number of interests or multiple recommendations or set of recommendations can be generated based on one or more interests. For example, a multi-criteria recommendation can be based on the last three games a user played and analyzing their themes, mechanics, or genres to suggest similar titles.

At 606, the gaming system can generate, using the machine learning model, the recommendation for the user device along with a reason for the recommendation, where the reason for the recommendation explains why the user is receiving the recommendation. The content for the recommendation can also be based on data from additional providers such as multimedia providers like YouTube, Twitch, and Spotify. Based on the interests of the user, the gaming system can gather relevant content for presentation to the user. Based on the interests of the user, the gaming system can provide a reasoning for the recommendation.

In some embodiments, the recommendation can be generated based on determining one or more propensities of the user based on the user specific data. Each proposed of the user can be assigned a score where the recommendation can be based on the one or more scores assigned to each of the one or more propensities of the user. Additionally, the reasoning for the recommendation can be based on the one or more scores. Similarly, the system can prioritize recommendations based on the intersection of the user’s activity patterns and broader influences, like seasonal events or trending content in the gaming ecosystem.

At 608, the gaming system can output the recommendation and the reason for the recommendation to the user at the user device. The recommendation(s) can be a video file, audio file, and/or image file that is/are used to present content on a user interface of a device (e.g., a game console). Recommendations can be integrated into the gaming system’s dashboard or home screen in visually appealing ways, such as personalized carousels, lists, or tiles labeled with and include a reasoning for the recommendation such as “Because You Played FIFA,” “Popular Among Your Friends,” or “Recommended Based on Your Recent Activity.” In some embodiments, the recommendation can be implemented automatically by the gaming system or in response to a user input.

In some embodiments, based on feedback regarding the user’s response to the recommendation and associated reasoning, the machine learning model can be further trained. For example, secondary user specific data can be received by the gaming system where the secondary user specific data is collected after the presentation of the recommendation and/or the associated reasoning. The effect of the recommendation on user behavior can be determined based at least in part on the secondary user specific data. The effect can comprise an indication of whether the recommendation has been implemented by the user. The effect can be determined the same or separate machine learning model(s). This feedback loop can be used to iteratively fine-tune the model to improve future content-based recommendations and associated reasonings.

Gaming systems often rely on batch processing and delayed updates for providing content recommendations to users. Moreover, gaming systems lack predictive capabilities, making them reactive rather than proactive. Using a machine learning model, the embodiments described herein can determine tailored content based recommendations that are most relevant to a user based on learned interests. For example, if a user has attended a particular concert recently, the model can identify music by the artist of the concert or similar music to recommend to the user. By automating the recommendation process, the computing system can reduce reliance on manual searches and improve recommendations to user of an entertainment environment. Additionally, the machine learning model can continuously improve its predictive accuracy by learning from prior successful recommendations, thereby enhancing its ability to address complex and nuanced requests over time.

Additionally, by centralizing data from multiple sources (e.g., game console, system database(s), external user devices, content providers), the gaming system can operate more efficiently, reducing the need for fragmented data processing. This centralized approach allows for faster data retrieval and allows the gaming system to operate smoothly even during high demand scenarios, such as live events or peak gaming hours. The ability to process and analyze data in real time also enhances system responsiveness, enabling content delivery without delays.

Additionally, the described embodiments can better predict resource needs, such as server capacity for multiplayer games, based on real-time user behavior and engagement trends, leading to improved scalability and reliability. For example, when a recommendation is presented, such as suggesting a multiplayer game that a user’s friends are currently playing, the system can predict that a certain percentage of users will act on that recommendation. For example, if historical data shows that 20% of users typically follow a recommendation to join an ongoing multiplayer game, the system can anticipate an increase in server load proportional to the size of the user base and the number of recommendations issued. This predictive capability allows the system to dynamically allocate resources, such as increasing server capacity or optimizing matchmaking algorithms, to handle the expected surge in activity.

### VI. Hardware Implementation

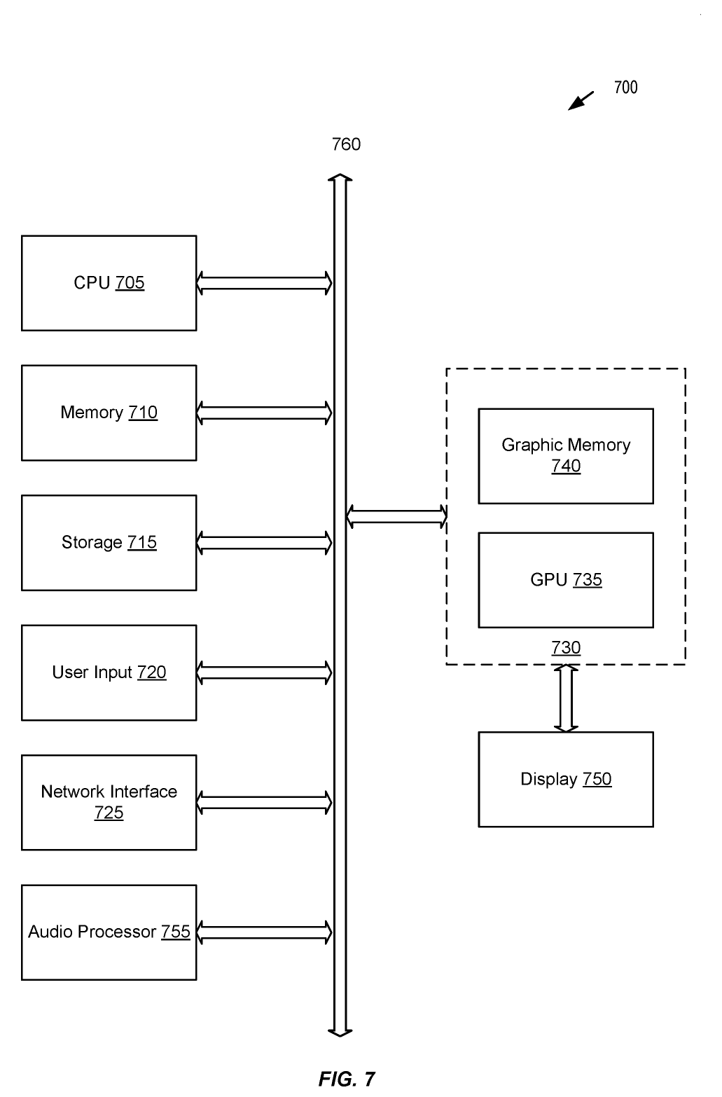

FIG. 7 illustrates an example of a hardware system suitable for implementing a computer system (e.g., gaming system 306 described above), according to embodiments of the present disclosure. The computer system 700 represents, for example, a video game system, a backend set of servers, or other types of a computer system. The computer system 700 includes a central processing unit (CPU) 705 for running software applications and optionally an operating system. The CPU 705 may be made up of one or more homogeneous or heterogeneous processing cores. Memory 710 stores applications and data for use by the CPU 705. Storage 715 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 720 communicate user inputs from one or more users to the computer system 700, examples of which may include keyboards, mice, thumb sticks, touch pads, touch screens, still or video cameras, and/or microphones. Network interface 725 allows the computer system 700 to communicate with other computer systems via an electronic communications network and may include wired or wireless communication over local area networks and wide area networks such as the Internet. An audio processor 755 is adapted to generate analog or digital audio output from instructions and/or data provided by the CPU 705, memory 710, and/or storage 715. The components of computer system 700, including the CPU 705, memory 710, data storage 715, user input devices 720, network interface 725, and audio processor 755 are connected via one or more data buses 760.

A graphics subsystem 730 is further connected with the data bus 760 and the components of the computer system 700. The graphics subsystem 730 includes a graphics processing unit (GPU) 735 and graphics memory 740. The graphics memory 740 includes a display memory (e.g., a frame buffer) used for storing pixel data for each pixel of an output image. The graphics memory 740 can be integrated in the same device as the GPU 735, connected as a separate device with the GPU 735, and/or implemented within the memory 710. Pixel data can be provided to the graphics memory 740 directly from the CPU 705. Alternatively, the CPU 705 provides the GPU 735 with data and/or instructions defining the desired output images, from which the GPU 735 generates the pixel data of one or more output images. The data and/or instructions defining the desired output images can be stored in the memory 710 and/or graphics memory 740. In an embodiment, the GPU 735 includes 3D rendering capabilities for generating pixel data for output images from instructions and data defining the geometry, lighting, shading, texturing, motion, and/or camera parameters for a scene. The GPU 735 can further include one or more programmable execution units capable of executing shader programs.

The graphics subsystem 730 periodically outputs pixel data for an image from the graphics memory 740 to be displayed on the display device 750. The display device 750 can be any device capable of displaying visual information in response to a signal from the computer system 700, including CRT, LCD, plasma, and OLED displays. The computer system 700 can provide the display device 750 with an analog or digital signal.

In accordance with various embodiments, the CPU 705 is one or more general-purpose microprocessors having one or more processing cores. Further embodiments can be implemented using one or more CPUs 705 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the disclosure is described with reference to specific embodiments thereof, but those skilled in the art will recognize that the disclosure is not limited thereto. Various features and aspects of the above-described disclosure may be used individually or jointly. Further, the disclosure can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the disclosure.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature’s relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the disclosure. For example, the above elements may merely be a component of a larger system, wherein other rules may take precedence over or otherwise modify the application of the disclosure. Also, a number of steps may be undertaken before, during, or after the above elements are considered. Accordingly, the above description should not be taken as limiting the scope of the disclosure.

What is claimed is:

1. A method comprising:
receiving, by a gaming system including a processor and a memory, user specific data of a user;
providing, by the gaming system, the user specific data to a machine learning model trained to determine a recommendation for a user device of the user, wherein the user device is integrated with the gaming system;
generating, by the gaming system using the machine learning model, the recommendation for the user device along with a reason for the recommendation, wherein the reason for the recommendation explains why the user is receiving the recommendation; and
presenting, by the gaming system, the recommendation and the reason for the recommendation to the user at the user device.

2. The method of claim 1, further comprising:
receiving, by the gaming system, general data of a group of users, wherein the machine learning model is trained based at least in part on the general data.

3. The method of claim 1, further comprising:
determining one or more propensities of the user based on the user specific data;
assigning a score to each propensity of the user;
determining the recommendation based on the score assigned to each of the one or more propensities of the user; and
generating the reason for the recommendation based on the one or more scores.

4. The method of claim 1, wherein the user specific data comprises user interaction data with a program interface provided by the gaming system.

5. The method of claim 1, wherein the recommendation is generated based on two or more criteria for generating the recommendation, and wherein the reason for the recommendation is based at least in part on the two or more criteria.

6. The method of claim 1, wherein the user specific data is received from a second user device associated with the user, wherein a predetermined set of data associated with the second user device is accessible by the gaming system.

7. The method of claim 1, further comprising:
implementing the recommendation at the user device automatically or in response to a user input.

8. The method of claim 1, further comprising:
receiving secondary user specific data, wherein the secondary user specific data is collected after presenting the recommendation;
determining effect of the recommendation on user behavior based at least in part on the secondary user specific data, wherein the effect comprises an indication of whether the recommendation has been implemented by the user; and
further training the machine learning model based at least in part on the secondary user specific data.

9. The method of claim 1, further comprising:
receiving a request from a user device to generate the recommendation based on identifying that a criteria for the user specific data is met on the user device.

10. The method of claim 1, wherein the machine learning model comprises one or more task specific intelligent agents and wherein the reason for the recommendation is based at least in part on a specific task of the task specific intelligent agent.

11. A gaming system comprising:
one or more storage media storing instructions; and
one or more processors configured to execute the instructions causing the system to perform operations comprising:
receiving user specific data of a user;
providing the user specific data to a machine learning model trained to determine a recommendation for a user device of the user, wherein the user device is integrated with the gaming system;
generating, using the machine learning model, the recommendation for the user device along with a reason for the recommendation, wherein the reason for the recommendation explains why the user is receiving the recommendation; and
presenting the recommendation and the reason for the recommendation to the user at the user device.

12. The gaming system of claim 11, the operations further comprising receiving general data of a group of users, wherein the machine learning model is trained based at least in part on the general data.

13. The gaming system of claim 11, the operations further comprising:
determining one or more propensities of the user based on the user specific data;
assigning a score to each propensity of the user;
determining the recommendation based on the score assigned to each of the one or more propensities of the user; and
generating the reason for the recommendation based on the one or more scores.

14. The gaming system of claim 11, wherein the recommendation is generated based on two or more criteria for generating the recommendation, and wherein the reason for the recommendation is based at least in part on the two or more criteria.

15. The gaming system of claim 11, the operations further comprising:
receiving secondary user specific data, wherein the secondary user specific data is collected after presenting the recommendation;
determining effect of the recommendation on user behavior based at least in part on the secondary user specific data, wherein the effect comprises an indication of whether the recommendation has been implemented by the user; and
further training the machine learning model based at least in part on the secondary user specific data.

16. The gaming system of claim 11, the operations further comprising receiving a request from a user device to generate the recommendation based on identifying that a criteria for the user specific data is met on the user device.

17. The gaming system of claim 11, wherein the machine learning model comprises one or more task specific intelligent agents and wherein the reason for the recommendation is based at least in part on a specific task of the task specific intelligent agent.

18. A gaming environment comprising the gaming system of claim 11 and the user device, and additional user devices providing general user data to the gaming system.

19. The gaming environment of claim 18, further comprising access to data from one or more content providers.

20. One or more non-transitory computer-readable storage media storing instructions that, upon execution by one or more processors of a system, cause the system to perform operations comprising:
receiving user specific data of a user;
providing the user specific data to a machine learning model trained to determine a recommendation for a user device of the user, wherein the user device is integrated with the system;
generating, using the machine learning model, the recommendation for the user device along with a reason for the recommendation, wherein the reason for the recommendation explains why the user is receiving the recommendation; and
presenting the recommendation and the reason for the recommendation to the user at the user device.
